(19) United States
(12) Patent Application Publication
(10) Pub. No.: US 2018/0247228 A1
(43) Pub. Date: Aug. 30, 2018

(54) System and Method for a Location-Based Cook-to-Neighbor Matching Platform

(71) Applicant: Sajna Kattil Veetil, (US)

(72) Inventor: Sajna Kattil Veetil, Hastings-on-Hudson, NY (US)

(21) Appl. No.: 15/432,318

(22) Filed: Feb. 14, 2017

(51) Int. Cl. G06Q 10/02; G06Q 50/12

(52) U.S. Cl. CPC G06Q 10/02; G06Q 50/12

(57) ABSTRACT

Technology has made dining a sharable experience through real-time updates, uploaded images and check-ins from either someone's place or restaurant. Conversations about meals happen between people present and then are shared with those who are connected to them afar. The technical field generally describes systems and methods for a peer-to-peer based dining experience. Specifically, this invention relates to systems and methods for matching users-more specifically, cooks and neighbors, using an interactive web-based matching platform for a social dining experience, utilizing location based services and other user-specific matching criteria.

### BACKGROUND

### Technical Field

The technical field generally describes systems and methods for a peer-to-peer based dining experience. Specifically, this invention relates to systems and methods for matching users-more specifically, cooks and neighbors, using an interactive web-based matching platform for a social dining experience, utilizing location based services and other user-specific matching criteria.

### Background of Related Art

Technology has made dining a sharable experience through real-time updates, uploaded images and check-ins from either someone's place or restaurant. Conversations about meals happen between people present and then are shared with those who are connected to them afar. Social media websites such as Twitter, Instagram, Facebook, Foursquare and Gastronaut all encourage people to discuss their dining activities in a virtual, social space. Apps can be downloaded to a user's smartphone to share updates. These systems allow a user to unilaterally communicate with his/her social network by posting status updates or broadcasting information. Present-day social networking platforms or dining platforms additionally offer users the ability to join or create a dining-based interest or activity group within the website.

For many people, cooking is a passion, and more importantly, can be therapeutic, stress busting, fulfilling, and comforting. More significantly, the added social dimension creates an outlet for people to be more communal and connected with their local community. With increased urbanization and other demographic trends, people are increasingly isolated. It is all too common for people to not have never even met their next-door neighbors. Since time immemorial, food has been a major thread in the social fabric of a community. This thread figures even more prominently now with the advent of the innumerable social media and dining platforms.

While there are dining platforms that will set a person up on a group dining experience, these services are generally run by professional chefs who don't receive requests, but rather simply post their menu of the day. Upon receiving a satisfactory number of guests, any number of the available platforms may confirm the event to the chef, along with all of the confirmed guests. However, if the pre-defined number of guests has not been satisfied, then the event is cancelled and the chef and guests are notified.

These dining platforms do not employ a true peer-to-peer platform because they are exclusive to pairing a professional chef to a guest user. This fact would effectively eliminate a whole share of wonderful cooks, who are just as passionate about cooking the food of their ancestry. Just because they may not have had formal training from a culinary institute and do not possess a chef's cap, doesn't mean that they couldn't provide an authentic, home-cooked meal. What's more, because the recipes weren't filtered down from an austere culinary pedagogue, mundanely reciting instructions on technique and ingredients, there would be a far richer context to the food. Context could include the first time the cook learned how to make the dish; from whom the cook learned the dish; interesting anecdotes of the learning experience, etc. Again, these anecdotes would enrich the dining experience, along with help to form stronger bonds between community members.

Moreover, these dining platforms essentially do not employ any matching algorithms or modules to pair the professional chef to the potential dining guest. The only filter is the posted menu of the day from the chef. The potential dining guest peruses through a listing of chef-posted meals and decides if he or she would like to join the table at the home of the chef. There aren't any sophisticated matching along multi-points of interest to ensure or suggest a likelihood of compatibility. Pictures or description alone of a chef-posted menu cannot reliably predict compatibility-the potential dining guest essentially has to take the word of the professional chef.

Finally, the extant dining platforms are limited to a conventional dining experience. Essentially, the chef posts a menu and the potential dining guest-based on the pictures and description posted by the chef-makes a decision to join the table. There are no other permutations of this. The lack of versatility of the various types of meal provisioning is glaringly apparent. Thus far, none of these dining platforms address this void. The potential dining guest does not have the option to request preferred meals; request meals based on preferred ingredients or techniques; pick-up, rather than have to join a table; observe the meal being cooked in front of the guest; cook the meal together; have the cook come to the house of the guest and cook the meal; sharing your recipe with the cook; having the cook sharing the cooking process via a video message, etc. Again, these non-conventional permutations of meal provisioning, strengthen local community ties, along with enriching the dining experience with a deep social context.

The final issue that plagues all peer-to-peer networks is the issue of trust. These peer-to-peer networks are proposing the sharing of intimate resources between presumable strangers. How can you trust that these strangers will treat these intimate resources with the same care as you do. The extant platforms attempt to solve this trust issue by incorporating a user rating system, wherein guests within the network rate chefs based on their previous experience or an aggregate of experiences. Again, the limitation with such a user-rating system for trust building is that it essentially requires to trust the rater. It lacks the depth and context compared to a cut-by-cut or flip-by-flip co-cooking experience between a cook and neighbor. Such an intimate experience would build sustainable trust and presumably foster strong bonds within a local community network.

Hence, there is need in the art for a computer and web-based marketplace system and method for substantively matching users based on a cook to neighbor matching platform for any permutation of a dining event or experience-fostering trust and social ties within a local community.

### SUMMARY

In light of the above, it is readily apparent that a need exists in the art for an efficient marketplace for home cooked expert food services. It is therefore a primary object of the invention to provide a marketplace for home cooked food that allows the cook and requestors of food services or neighbors to find one another based on a sophisticated matching. Such matching is based on multi-point areas of interest that provides matched cooks-neighbors with a versatility of dining experiences or events. These events, in turn, guarantee a social context with a certain level of depth, enriching the dining experience, building community ties, and providing the necessary trust for a sustainable peer-to-peer network.

The present invention fills the void left by the extant dining platforms. It is directed to a web-based, peer to peer (P2P) electronic system and method which provides easy access to fresh home cooked food. More importantly, a platform, where the locals and neighbors can request authentic and traditional home cooked food from their neighbor cooks; meet new people in their local community; and get intimate insight into a different culture, tradition and cuisine, is disclosed. A system where one can request customized meals, a special diet meal, or where one can upload a recipe and request the cook to make it, is further disclosed. Guest can even cook the requested meals with the matched cooks, in the confines of their own home. Peer-to-peer deployment with a multi-point matching module to match cooks and neighbors for a versatility of dining experiences is generally disclosed.

According to an object of the present invention, the system is configured to receive food preference attributes which enable a profile to be created by a profile module, wherein the profile is an abstract data structure; Further yet, a request is received from a first user profile by the requesting module, wherein the request comprises of a specific criterion related to a potential dining experience, occasion, or event, or a generic request. Matching of the first user profile to at least one user profile from a plurality of member profiles is performed by a matching module, wherein the match correlates tagged food preference attributes from a request or profile by the first user profile to tagged food preference attributes from at least one second user profile based on matching rule and score and is further based on a number of, or a degree of tagged correlations.

It is another object of the present invention to provide for a method of enabling a profile to be created by a profile module, wherein the profile is an abstract data structure; Further yet, requesting from a first user profile by the requesting module, wherein the request comprises of a specific criterion related to a potential dining experience, occasion, or event, or a generic request. Matching of the first user profile to at least one user profile from a plurality of member profiles is performed by a matching module, wherein the match correlates tagged food preference attributes from a request or profile by the first user profile to tagged food preference attributes from at least one second user profile based on matching rule and score and is further based on a number of, or a degree of tagged correlations.

The details of one or more embodiments are set forth in the accompanying drawings and description below. Other features, objects, and advantages of the subject matter will be apparent from the description and drawings, and from the claims.

### BRIEF DESCRIPTION OF THE DRAWINGS:

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1 is a network diagram according to an aspect of the invention.

FIG. 2 is a network diagram according to an aspect of the invention.

FIG. 3 is a system block diagram of the cook-neighbor reservation system according to an aspect of the invention.

FIG. 4 is a system block diagram of the matching module according to an aspect of the invention.

FIG. 5 is an interaction flow diagram according to an aspect of the invention.

FIG. 6 is a process flow diagram according to an aspect of the invention.

FIG. 7A is a user interface diagram according to an aspect of the invention.

FIG. 7B is a user interface diagram according to an aspect of the invention.

FIG. 7C is a user interface diagram according to an aspect of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

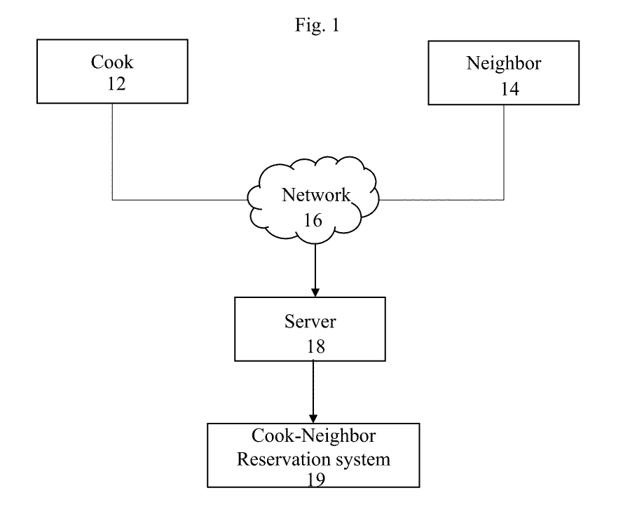

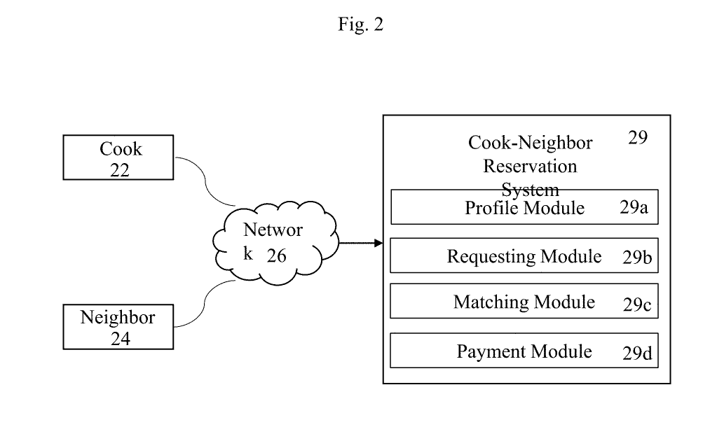

FIGS. 1 and 2 is a network diagram illustrating a high-level network architecture in accordance with an aspect of the invention. Cook-neighbor reservation systems 19, 29 are deployed on computer platforms and connected centrally or distributive to a server or servers 18. The system may comprise at least an operating system, memory element, communication device, and storage device coupled to a processor, and are further configured with a set of software applications operative in providing at least one of, matching, tagging, and or payment services to a plurality of cooks 12, 22 and neighbors 14, 24 operating management systems. Operating systems manage the executions of the application programs and hardware resources and could be anyone of, UNIX, Linux, Windows, OS, and the like. Storage is a computer readable media, storing software program and data structures containing encoded information for operations of server. The communication device may be a network interface, such as Ethernet interface or other type of wireless interface that couples the operations service to external networks. The network 16, 26 may be an Internet Protocol (IP) network, the Internet, a mobile communications networks, or a local area network to communicate content and delivery content services.

The cook-neighbor reservation system 19, 29 may be configured to construct a profile based on at least one data-mined behavioral criteria beyond user-entered information. This information may be crawled from any one of a social media site or cached metadata tag, for example. Alternatively, cook 12, 22 and neighbor 14, 24 may be able to log in by cross-logging into at least one social media site (Facebook, twitter, Instagram, snap-chat, etc.), thereby allowing the system to perform a de minimus data extraction related to a basic social or demographic characteristics for purposes of a user profile construction. Additionally, user profiles may be populated by other non-user generated means, such as web traffic, cached information, purchasing history, etc. In yet other alternative embodiments, the user profile may be generated as a result of user-inputted information, as opposed to crawled or queried.

Still in reference to the platform, a cook-to-neighbor reservation system 19, 29 may be in wireless communication to a network 16, 26 via a web server 18. The cook 12, 22 and at least one neighbor 14, 24 are also connected to the network 16, 26. As illustrated in FIGS. 1 and 2, an exemplary embodiment may comprise a cook 12, 22 and neighbor 14, 24 communicating with a cook-to-neighbor reservation system 19, 29 via a network 16, 26 and server 18. The cook-to neighbor reservation system 19, 29 supports a number of functionalities through a device layer graphical user interface, such as a cook 12, 22 sign up, sign in; neighbor 14, 24 sign up, sign in; profile module 29a, requesting module 29b, matching module 29c, payment module 29d, verification system, suggestion module, and payment module. In some embodiments, an avatar (user profile encoded data structures representing 3D graphical characters representing a cook or neighbor) may be employed. In other embodiments, an actual photograph of either the cook 12, 22 and, or neighbor 16, 26 may be used to visually represent the user profile.

As illustrated in FIG. 2, the system includes a cook-neighbor reservation system 29, connected to a network 26, which may be any one of secure communications networks. The cook-neighbor reservation system 29 may include a profile module 29a, requesting module 29b, matching module 29c, and a payment module 29d, facilitating payment transactions between the neighbor 24 and cook 22. In alternative embodiments, a verification system may be operable to ensure a satisfactory fulfillment of mutually agreed services between cook 22 and neighbor 24. The verification system may further be operably coupled to a user rating system and, or the payment module. Once completion of transaction is verified by any one of the cook 22 or neighbor 24, the neighbor 24 may be directed to a payment track powered by a payment engine or module. Such a payment module may further be operably coupled to an intermediary account. The intermediary account may serve as a 3rd party account holding funds from the neighbor in escrow, prior to satisfactory fulfillment of services. Once fulfilled, the remaining or full portion of the escrowed funds may be disbursed from the intermediary account. The verification-payment track may, in other embodiments, be void of an intermediary account, and rather just disburse the full amount of funds from a neighbor 24 payment agents upon fulfillment of order by cook 22. In other embodiments, the verification system may be operably coupled to a user rating system, wherein the user rating is tabulated based in large part by verification from the verification system.

In some embodiments (not shown in FIG. 2), a payment agent allows a neighbor 24 via a user device interface-to authorize payment into an intermediary account, further verify satisfactory fulfillment of dining event provisioning by the cook 22 and report unsatisfactory conditions related to the provisioning. In alternative embodiments, payment directives are executed by a payment module, in direct interaction with a neighbor 24/cook 22 payment agents, obviating the need for an intermediary account. In yet other embodiments, the neighbor 24 may automate authorization and verification for various system processes, obviating the need for the requester/neighbor 24 to have to do so for each transaction. The cook-neighbor reservation system may provide push-notifications of payment from a neighbor 24 directly or from an intermediary account; push-notifications of unsatisfactory fulfillment; direct-messaging capability between cook 22 and neighbor 24; and access cloud-backed analytics.

Although not shown in FIG. 2, the cook-neighbor reservation system 29 may be connected to a database, and, or a cloud, which may include at least anyone of the following data: 1. neighbor/cook Name; 2. neighbor/cook Date of Birth; 3. neighbor/cook Address; 4. neighbor/cook Account Information including, but not limited to, username, password, verification processes, personal information, audio and video messages; 5. cook/neighbor bank account information, including, at least one of, account number, routing number, PayPal account information etc.; and 6. Financial intermediary account information.

In continuing reference to FIG. 2, the cook-neighbor reservation system 29, further comprises of a profile module 29a, which builds profiles based on extant user-specified and non-user generated information and matches cook 22 profiles and neighbor 24 profiles along multiple points of threshold-dependent tagged, dining-based attributes by a matching module 29c. Threshold-dependent matching is based on a matching rule and generating a matching score above a threshold based on a number of, or a degree of correlations between similarly tagged dining-based attributes. Further yet, in alternative embodiments, once the neighbor 24 receives a list of cooks based on the matching score, the neighbor 24 may use the auction module to find an ideal cook candidate. Further yet, in yet another alternative embodiment of the invention, once the neighbor 24 confirms a cook 22, a contract between the neighbor 24 and cook 22 triggers transfer of at least a partial amount of the contract amount into an intermediary account by a payment module 29d, wherein satisfaction of a contract obligation based on a verification agent causes disbursal of at least a partial amount of the contract amount from the intermediary account to a cook 22 account.

Further yet, obligations may include, but not limited to, allowing the neighbor 24 to request a meal of his or her choice; to request a meal with a specific recipe to be executed by the cook 22; to dine in or pick up from the cook's 22 home; watch the cook 22 prepare the meal from the neighbor's 24 or cook's 22 home; cook with the cook 22 at the cook's 22 home or neighbor's 24 home; request a video tutorial of the cooking by the cook 22; etc. The more conventional scenarios of scrolling down cook-posted menus of the day are also possible. In yet another scenario, geo-location serves as the prevailing matching criteria between cook 22 and neighbor 24.

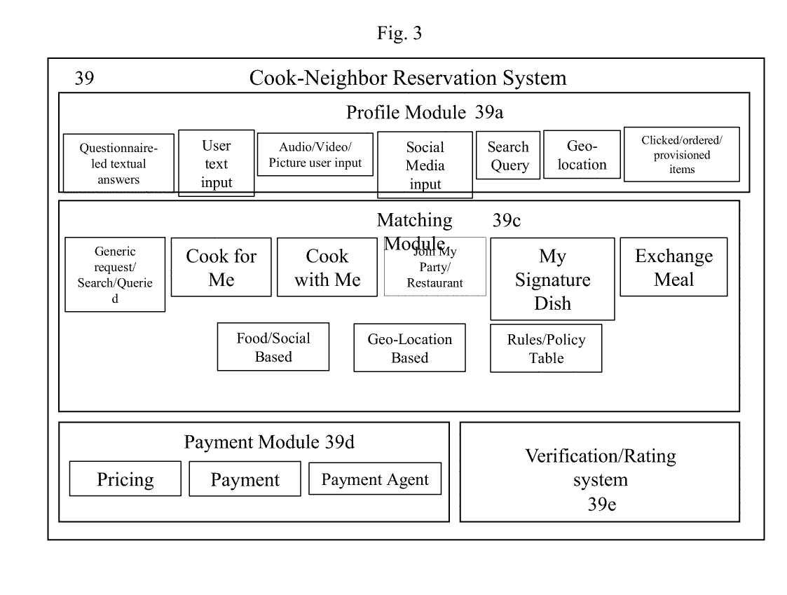

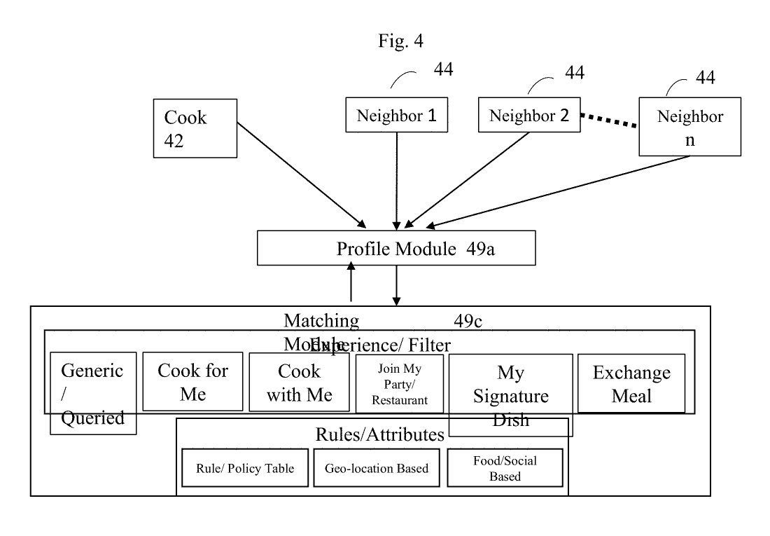

Now in reference to FIGS. 3 and 4. An exemplary embodiment of the cook-neighbor reservation system 39,49 may comprise: a profile module 39a, 49a; a matching module 39c, 49c; a payment module 39d; a processor; a storage element coupled to the processor; encoded instructions; wherein the system is configured to: receive food preference attributes which enable a profile to be created by the profile module 39a, 49a; receive a request from a first user profile by the requesting module, wherein said request comprises of a specific criteria related to any one of a potential dining experience, occasion, event, or a generic request; match the first user profile to at least one user profile from a plurality of member profiles by a matching module 39c, 49c, wherein said match correlates tagged food preference attributes from a request or profile by the first user profile to tagged food preference attributes from at least one second user profile based on matching rule and score, further based on a number of, or a degree of tagged correlations; and wherein an acceptance between at least two user profiles, triggers transfer of at least a partial amount of the entire confirmed order amount from a first user profile payment agent into a second user profile payment agent by the payment module 39d.

As an exemplary embodiment of the cook-neighbor reservation system 39, 49, an available inventory of cook profiles stored in a cook profile system is provided, whereby cook profiles define cook offerings, said cook offerings defining at least one of the following: location, time, activity, place of origin, cooking preferential, cost, type of cuisine, delivery options, cook rating, credentials, experience, written profile, video introduction, and wherein the cook offerings and cook rating is a curated, weighted-aggregate of converged, service-specific real-time data, streaming data. Alternatively, a cook profile system may not have an inventory of cook profiles. Conversely, cook profiles may be stored exclusively in the storage layers of a cook profile management system. Further yet, a cook profile system or inventory may be converged with a neighbor profile system stored in a cook-neighbor reservation system 39, 49.

Similarly, the cook-neighbor 39, 49 system may be coupled to a neighbor profile system having an available inventory of neighbor profiles, whereby neighbor profiles define meal request criteria, said meal request criteria defining at least one of the following: location, time, preferred meals, preferred meal events, meal event prep budget estimates, place of origin, neighbor rating, neighbor written description, type of cuisine, delivery options, video introduction, and wherein the neighbor request and neighbor requestor rating is a curated, weighted-aggregate of converged, service-specific real-time data. Alternatively, a neighbor profile system may not have an inventory of neighbor profiles. Conversely, neighbor profiles may be stored exclusively in the storage layers of a neighbor profile management system. Further yet, a neighbor profile system may be converged with a cook profile system stored in a cook-neighbor reservation system 39, 49. Optionally, a cook may be a neighbor, or a neighbor may be a cook.

Once a meal event query is prompted, a cook profile and neighbor profile and, or meal event request may be paired based on matching service request, meal event request criteria based on a neighbor profile with a cook profile by a matching module 39c, 49c and both, cook and neighbor will be notified of the match, with an exchange of at least a partial profile information. The partial profile information may include a pre-defined meal event cost, or may be further augmented with a post-facto cost estimate based on the specific meal event request query.

In continuing reference to the cook-neighbor reservation system 39, 49 and the prompting of a meal event query, said system may be configured to perform a search based on matching rules from a neighbor profile for a customized and individualized meal event experience, said search matching a neighbor profile and, or meal event request query against a plurality of tagged cook profiles to determine the highest scored match between neighbor and cook in a threshold-dependent manner by a matching module 39c, 49c. Said matching module 39c, 49c matches neighbor with cook along user-created criteria (location, time, activity preference, etc.). The matching module 39c, 49c may match a neighbor to a cook, wherein said match, correlates terms from a meal event request to a tagged attribute from a cook profile by a tagging module or by the matching module 39c, 49c. Based on a matching rule, generate a matching score based on a number of, or a degree of correlations. The cook is then matched with a neighbor based on the matching score. Alternatively, neighbors may be matched with candidates of ranked cooks-allowing neighbors to choose cooks with a lower matched score. Alternative embodiments may include a match process that does not entail a scoring scheme or threshold-dependency, but rather, just simple keyword matching between meal event query and cook profile tags-tagged by the tagging module or matching module 39c, 49c. In yet other embodiments, tagging and, or matching may simply be along a single point of interest-geo-location based proximity.

Although not illustrated in FIG. 3 or 4, the system architecture may comprise three major logical layers: storage, query/analysis, and the application layer. The data storage layer consists of any one of either a non-relational, relational, ontology, cloud storage, and/or 3rd party databases. Data sets may communicate with different storage layers depending on the type of sensor, captured, crawled, or inputted data. Data points may be crawled for or keyword searched for and curated depending on the type of data/format it is and tagged by data attachment index, tag mapping, and block mappings by a tagging module or by the matching module 39c, 49c in order for it to be retrieved quickly. The query and analysis layer consists of the workflow engine and ontology engine. The former is involved in the scheduling and execution of workflows and processes. The latter is involved in the annotation of data sets and providing the semantic substrate to manipulate the various formats of data sources into a single, standardized format. Moreover, it is the ontology engine within the profile module 39a, 49a that enables integration and aggregation of different data formats in order to populate the respective fields of the respective profile. The profile module 39a, 49a with conditional triggers, perform specific actions when conditions are satisfied. For example, when data satisfies a user profile field, the ontology engine and profile module facilitate the transfer of the designated data for specific user profile field population. The matching module 39c, 49c performs a keyword search query against a plurality of cook profiles by a cook profile probe-pairing cook with a neighbor based on matched search criteria and matched user profiles. Matching in some embodiments encompass using a scoring matrix of aligned interests and a scoring-threshold dependency. Other embodiments involving the matching module 39c, 49c may not involve a scoring matrix or a scoring-threshold, but alternatively, just a threshold of a number of aligned food-based or meal event attributes. Finally, the application layer consists of components that are involved in the management, access, and distribution of the data. An API service component may offer an easy-to-use interface for access, management, visualization of third-party data, such as Google Maps, social media sites, micro payment sites, etc.

Alternatively, a pricing module (not shown) may estimate the cost based on the meal event request query and cook profile and inform cost component of the partial information profile. A reservation module or verification system 39e then may prompt confirmation of engagement of a meal event purchase agreement. The reservation module or verification system 39e may also be involved in cancelling engagements and is also operably coupled to the payment module 39d. In alternative embodiments, the matching module 39c, 49c overlooks confirmation of engagement and is directly in operable communication with the payment module 39d. In some embodiments, the system 39, 49 over a wireless network architecture, comprises a means to receive aggregated data, apply pricing rules to the aggregated data to calculate in real-time a dynamic price, whereby said dynamic price is calculated by a pricing module. The pricing module may take into account any one of the following factors: meal event preference, cost index, lifestyle factors, cook/neighbor user ratings; communicate to neighbor at least one matched cook with a suggested dynamic price.

In other embodiments, an auction module (not shown) may allow a plurality of matched cooks the ability to bid or secretly bid for the requested meal event. The auction module may be configured to receive at least one bid from at least one cook; determine the winning bid using an auction module applying auction rules; and communicate the winning bid to the cook and neighbor in preparation for payment processing and fulfillment.

Now in reference to the bidding features, once all purchasing criteria are selected by neighbor, said neighbor initiates bidding between local cooks by forwarding total funds into a financial intermediary account held by a third-party service provider on behalf of the cook and neighbor. The funds represent the total ceiling value of what a neighbor intends to spend on any given meal event. Local cooks may become notified of the triggered request, the neighbor's meal event preferences, and forwarded funds. The forwarded funds, additionally, serve as a show of good faith to the cook, incentivizing bidding. The plurality of cooks will then authenticate the forwarded funds in the intermediary and will begin competitively bidding based on the pre-defined purchasing criteria. Let's suppose cook A bids at 0.8× (Cook with Me' dynamically priced value or ceiling value set by neighbor) and y delivery time and cook B bids at 0.9× (Cook with Me' dynamically priced value or ceiling value set by neighbor) and y+1 delivery time, the bidding algorithm will make a determination of the most competitive bid based on the weighted preferences of the neighbor. Let's suppose cook A is selected at 0.8×, the intermediary may then return the balance back to the neighbor of 0.2×. The intermediary may forward half of the cooks ask price ½ (0.8×) and release the other half to the cook upon satisfactory completion of the task confirmed by the verification agent 39e. Alternatively, the intermediary may forward the entire amount of the cooks ask price 1/1 (0.8×) only upon satisfactory completion of the meal event (Cook with Me') confirmed by the verification agent 39e. In this full disbursal upon completion embodiment, half disbursals at any point during meal event engagement is not necessary.

In an alternative embodiment, neighbor may forward funds into the intermediary and request a multiple of meal event services with neighbor preferences. Selected local cooks will be notified of neighbor's requests and funds, and will proceed to bid for neighbor's multiple services. For example, neighbor 1 selects ‘Cook with Me’ and ‘Cook my Recipe’, along with any other neighbor meal event criteria, and triggers the bidding by forwarding the ceiling funds into the intermediary. The total fund may have different ceiling values depending on whether it's for ‘Cook with Me’ or ‘Cook my Recipe’. The neighbor doesn't have a preference for either, just wants either or maybe both, so long as it is below or at his/her ceiling. Let's suppose cook A wins the bid for the ‘Cook with Me’ at 0.6× (‘Cook with Me’ ceiling). The remaining fund balance is returned to neighbor 1 and a request to initiate another bid for the ‘Cook my Recipe’ is sent to user at the earlier defined ‘Cook my Recipe’ ceiling value. The bidding for the ‘Cook with Me’ will be triggered once the earlier defined ceiling value is forwarded into the intermediary. In the instance cook floor values are not willing to meet neighbor ceiling values, the bid will automatically expire within a set period of time according to neighbor preference and a request to initiate another bid with a suggestion of raising the ceiling value to meet at least one cook floor value will be prompted.

In another embodiment, the intermediary may act as a pre-paid account, whereby subsequent delivery of meal events is charged against the pre-paid intermediary account, rather than just on a bid-bid basis. Variable amounts of value can be loaded onto the neighbors intermediary account. Another advantage of the pre-paid system would be in situations such as the previous hypothetical, in which multiple items are bid for, one item is selected at 0.6× for instance (‘Cook with Me’ event, for example) and the balance needs to be refunded to the neighbor to reinitiate the bid. In the prepaid embodiment, the remaining balance can stay in the intermediary and the neighbor would have the choice of triggering a new bid with the balance or loading value onto the account and rebidding for another meal event, say, the ‘Cook my Recipe’ service, for example.

In yet another added system feature, a payment module 39d configured to: process the meal event transaction, said payment module 39d facilitating the dispensing of funds from the neighbor to a matched or chosen cook, or matched cook with a winning bid upon satisfaction of bidding obligations. In other embodiments, a payment module 39d may be configured to process the meal event transaction—even transactions not bundled to the bidding or auction features. In other embodiments, an intermediary payment gateway may be established to serve as an escrow, storing the full amount of funds from the neighbor and disbursing half of the funds to the cook upon satisfaction of bidding obligations, or reservation obligations, and the final half of funds from the intermediary payment gateway to the cook upon full fulfillment of services.

In yet other embodiments, the payment module 39d may simply be coupled to a bank account and, or credit card account of the neighbor and cook, wherein funds are drawn from the neighbor's bank account and subsequently transferred to the bank account of the cook by the payment module 39d. Just as in the case of the intermediary account, payments from the neighbor account may be disbursed in partial amounts or in a full amount to the cook account by the payment module 39d.

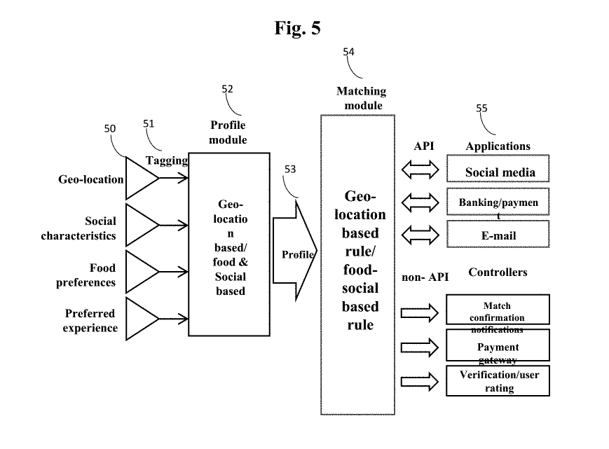

FIG. 5, is an interaction flow diagram according to an aspect of the invention. In an exemplary embodiment of the invention, the cook-neighbor reservation system receives food preference attributes 50 from users, which enable a profile 53 to be created by the profile module 52. The cook-neighbor system receives a request from a cook by the requesting module 50, wherein the request may comprise of a specific criterion related to any one of a potential dining experience, occasion, event, or a generic request. The tagging module 51 further tags based on any one of geo-location, food preferences, experience of the cook or other food and social based attributes/inputs. Additionally, in another embodiment of the invention, a generic request trigger for the requester module is based on any one of, a user's authorization, access, and, or initialization. Further, the requester module interacts with the matching module 54 to initiate a short-cut match of at least two users based only on geo-location.

Further yet, the matching module 54, matches the first user profile to at least one user profile from a plurality of member profiles by correlating the tagged 51 food preference attributes from a requestor profile 50 by the first user profile to tagged food preference attributes from at least one second user profile based on matching rule and score. The acceptance between at least two user profiles, may trigger a series of API or non-API based applications 55. For example, an acceptance between two user profiles may trigger a banking/payment application, where a transfer of at least a partial amount of the entire confirmed order amount from a first user profile payment agent into a second user profile payment agent may be executed by an API based payment application involving the users banking information. In another example, an acceptance between two user profiles would trigger a social media or location based API application, where the users may post their event on a social media website, or locate neighbor for delivery options.

Further yet, in an embodiment of the invention, the acceptance between two user profiles may also use non-API based controls 55, for example, a match notification may be sent to both user profiles confirming their match. In another instance, users may be directed towards a verification/user based rating system to rate anyone of, food experience, cook ratings, quality/quantity of food.

In yet another embodiment of the invention, a confirmation of a match between at least cook and neighbor may lead to a triggering of a non-API 55 based payment gateway, wherein at least a partial amount of the entire confirmed order amount is received from the first user profile (neighbor) payment agent into an intermediary account prior to disbursal of at least the partial amount of the entire confirmed order amount to the second user profile (cook) payment agent. Further yet, the cook-neighbor reservation system of may transfer at least a partial amount of the entire confirmed order amount is received from the first user profile (neighbor) payment agent to the second user profile (cook) payment agent upon match confirmation notification between at least a pair of cook and neighbor. Further yet, the payment system may comprise of, receiving a portion of a confirmed order amount from any one of the user's profile payment agent into an administrative payment account.

In another embodiment of the invention, the profile module 52 may mark at least one food preference attribute from a user profile input by a food preference marker, where the mark may be based on a textual proximity to any one of an adjective, geographic reference, and, or ethnicity reference. Further, the profile module may mark at least one food preference attribute from a user profile input by a food preference marker, where the mark may be based on matched food preference attributes listed in a pre-and, or and, or intelligently defined library. Additionally, in another embodiment, the user profile module 52 may create a user profile based on a user profile input comprising of any one of a questionnaire-led textual answers, user-volunteered textual input, video input, photograph input, social-media feed, search query, home address, geo-location, clicked items, ordered items, and, or provisioned items.

In yet another embodiment of the invention, the verification/rating system, rates the users based on at least one of, a quality of service review, quality of food review, time of completion of order, and, or timely payment for order. Additionally, the matching module of the cook-neighbor reservation system, matches user profile 1 with at least one user profile 2 based on at least any one of the following user profile inputs: today's menu, cook for me, cook with me, join my party, my signature dish, cook my recipe, cook with special dietary needs, join me at a restaurant, and, or exchange meal. Further yet, the matching module matches a plurality of users based on a ranking of highest matching rule score. Subsequently, after the matching module matches at least two users, it may interact with a notification system to notify any one of the users of any one of a highest scored match and, or a ranking of highest scored matches. The matching score is based on a matching rule, wherein, the matching rule gives a highest weighted average to any one of a residential location of a user 1 and user 2, and, or geo-locations of user 1 and user 2. Further yet, the matching rule gives a highest weighted average to a user rating of any one of user 1 and, or user 2. Alternatively, a plurality of users may be matched using the matching module at a given time.

In another embodiment of the invention, a user may search and or scroll a listed cook's post, wherein the cook's post may be any one of a listed dish, location, time of service, price, delivery options. Additionally, a notification system may notify inputs or posts from a plurality of users.

In yet another embodiment of the invention, a method flowchart of the cook-neighbor reservation system comprises the steps of: (1) receiving food preference attributes which enable a profile to be created by the profile module, (2) receiving a request from a first user profile by the requesting module, wherein said request comprises of a specific criteria related to any one of a potential dining experience, occasion, event, or a generic request, (3) matching the first user profile to at least one user profile from a plurality of member profiles by a matching module, wherein said match correlates tagged food preference attributes from a request or profile by the first user profile to tagged food preference attributes from at least one second user profile based on matching rule and score, further based on a number of, or a degree of tagged correlations, and finally (4) triggering transfer of at least a partial amount of the entire confirmed order amount from a first user profile payment agent into a second user profile payment agent by the payment module, upon acceptance between at least two user profiles.

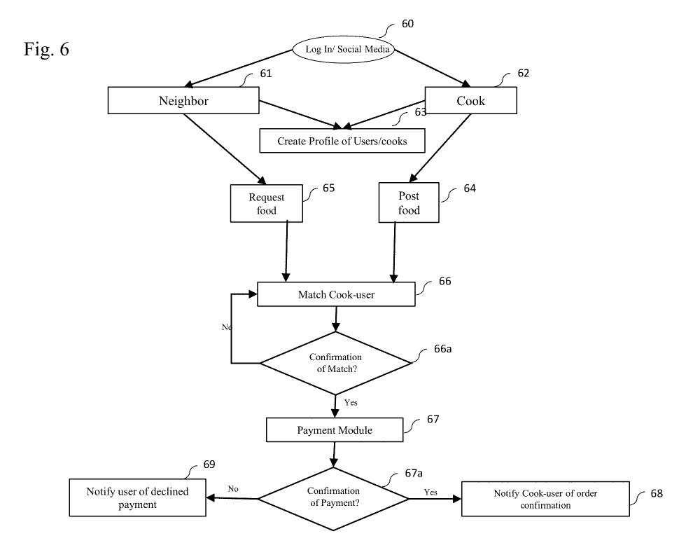

FIG. 6 is a process flow diagram according to an aspect of the invention. In an exemplary embodiment of the invention, the cook-neighbor reservation system, the cooks and neighbors can login 60 into the system on any one of, or plurality of, PC, laptops, tablets, and any handheld, wearable and or mobile devices, using either an email/password or via any social media based application/website 60, which via the profile module creates a profile for each user and or cooks. The neighbors 61 and the cooks 62 respectively, request 65 and post 64 food preference attributes which may be based on a specific criterion related to any one of a potential dining experience, occasion, event, or a generic request. Subsequently, in an embodiment of the invention, matching 66 the user profile to at least one cook profile from a plurality of member profiles is performed by a matching module. Once the match between the neighbors 61 and cook 62 is confirmed 67a by a partial amount of the entire order amount is transferred from the payment agent into the cooks' payment agent by the payment gateway system 67. Once the confirmation of payment 67a is verified, a notification 68 is sent to the neighbor 61 and cook 62 about the order confirmation.

Further yet, in another embodiment of the invention, if the cook 62 to neighbor 61 match is not confirmed then a request is made to match the neighbor 61 and the cook 62. A plurality of requests may be made for an exact match to occur between the neighbor 61 and the cook 62. Additionally, if the payment 67a is declined 69, then the system notifies the neighbor 61 of a decline payment. Alternatively, the system may offer the neighbor 61 for another form of payment.

Further yet, in an alternative embodiment of the invention, the cook 62 and the neighbor 61 may have a different set of login structures. The login and or sign up for the application may use a traditional route of entering username and password or may have the capability of using anyone of the user's social media accounts.

In yet another exemplary embodiment of the invention, a food ordering system may comprise of a requesting module; a matching module; a processor; a storage element coupled to the processor; encoded instructions, wherein the system is configured to, receive a generic request from a first user profile by the requesting module. Further yet, the generic request may comprise any one of, a first user authorization, access, and, or initialization and subsequently, match the first user profile to at least one user profile from a plurality of member profiles by a matching module. Additionally, in an embodiment of the present invention, the match may be based on geolocation inputs of the first user and at least one other user that have listed any one of a cooked item, cooking item, request receiving, and, or cooking active.

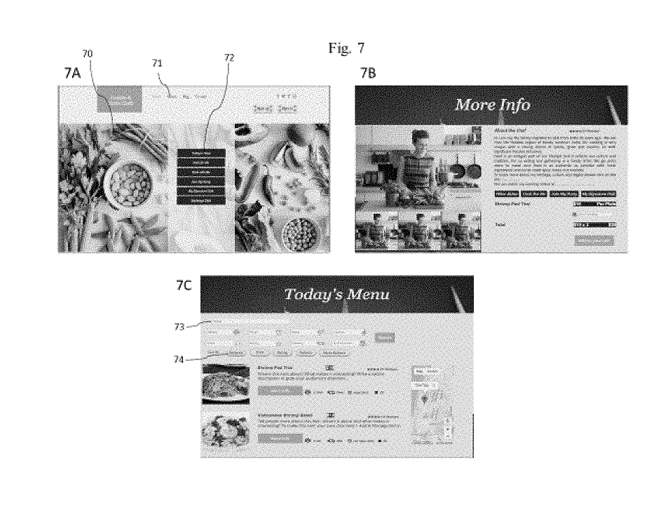

FIG. 7A-C, illustrates a screenshot of an exemplary virtual space interface, according to an embodiment of the invention. Virtual space display 70 is a display of a virtual space interface, which includes a query bar 71 top centrally located. As seen in FIG. 7A, the query bar 71 may be a Boolean search of the world-wide web or a search of any variety of spaces and tool layers available on the system. The click tabs 72 are positioned within display 70 suggests the versatility of tools at the disposal of a session. The click tabs 72 include a today's menu, cook for me, cook with me, join my party, my favorite dish, join me at a restaurant, and exchange meal. In one instance, a plurality of users may use the click tabs 72 to view the listed dish within closest proximity; menu for the day; request a meal; request a meal with specific ingredients/recipes; book sessions with the cook to learn to cook/watch the cook; join matched cooks or neighbors at a suggested restaurant; as well as click on the exchange meal tab to exchange their meals with other users. In another embodiment of the invention, as seen in FIG. 7C, once a user clicks the Today's menu tab from the click tabs (72, as shown in FIG. 7A), the user is able to see all the posts from the various chef's. The user is further able to narrow or sort the search using keywords 73, for example, ‘Thai food’, ‘vegetarian’, ‘gluten free’ etc., as well as sort by at least one of, the distance, price, rating, delivery options 74. As shown in FIG. 7B, in yet another embodiment of the invention, the user's may also narrow the search based on ratings of the cooks.

In another embodiment of the invention, virtual interface display 70 may have a note or chat box (not shown) associated with a plurality of user for sending instant notifications and alerts of requests or posts, Chat boxes may be designated with at least 2 color-code identifier corresponding to the color code of each respective user. Alternatively, the chat box 36, 38 may be user designated by any one of user identifier or nomenclature. In yet other embodiments, chat box layer may display a private note box 34, along with one other text box, visible to the group. This one chat box may allow users to input text into the single display, and each user may be designated by any one of a user identifier, nomenclature, 10 and, or user-specific color-code. Any number of note or chat boxes may be opened, depending on the number of users in the group.

Finally, in yet another embodiment of the invention (not shown), a unit or device may be provided. Such device may include a user interface, wherein the user interface may be integrated as a built-in console display. Any type of user interface display may be disclosed, including a mobile device display, a wearable device display, monitors, or any type of access device, without departing from the scope of the invention.

In a preferred embodiment, the user interface display may include a display page for receiving a request for a meal selection. The request being from a menu, a meal suggestion engine, or user-initiated. The display page may then prompt a user to confirm the request. Other embodiments may include a display page that does not require a user to confirm the request, and instead, signals confirmation of the request and initialization.

In yet another embodiment, the user interface display may instead include a voice-activated request option receiving a request voice command, whereby the request voice command may be in communication with a voice-activated module querying at least one pre-defined database based on the request voice command. The voice-activated module may be in communication with a natural language module, whereby the request voice command is sent from the voice-activated module to the natural language module. The natural language module may be configured to convert the request voice command into a meal request instruction querying at least one pre-defined database based on the request voice command.

In yet another embodiment, the user interface display may receive a request voice command for a meal request selection and interact with a user via voice response by having a voice activated module in communication with the natural language module and the voice activated module in communication with a voice response module, whereby the voice response module alerts the user of the various stages of the request compliance via the voice-activated user interface using natural language to describe the various stages of processing,

Further yet, the cook-reservation platform may be operatively coupled to an extant voice-activated home automation unit, such as Amazon Echo. The platform may be configured to interact with the voice request and commands from the home automation unit to deliver provisioning via the units voice modules.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A cook-neighbor reservation system comprising:
a profile module;
a requesting module;
a matching module;
a payment agent;
a payment module;
a processor;
a storage element coupled to the processor;
encoded instructions;
wherein the system is configured to:
receive food preference attributes which enable a profile to be created by the profile module;
receive a request from a first user profile by the requesting module, wherein said request comprises of a specific criteria related to any one of a potential dining experience, occasion, event, or a generic request;
match the first user profile to at least one user profile from a plurality of member profiles by a matching module, wherein said match correlates tagged food preference attributes from a requestor profile by the first user profile to tagged food preference attributes from at least one second user profile based on matching rule and score, further based on a number of, or a degree of tagged correlations; and
wherein an acceptance between at least two user profiles, triggers transfer of at least a partial amount of the entire confirmed order amount from a first user profile payment agent into a second user profile payment agent by the payment module.

2. The system of claim 1, wherein at least a partial amount of the entire confirmed order amount is received from the first user profile payment agent into an intermediary account prior to disbursal of at least the partial amount of the entire confirmed order amount to the second user profile payment agent.

3. The system of claim 1, wherein at least a partial amount of the entire confirmed order amount is received from the first user profile payment agent to the second user profile payment agent.

4. The system of claim 1, wherein the profile module marks at least one food preference attribute from a user profile input by a food preference marker, wherein said mark is based on a textual proximity to any one of an adjective, geographic reference, and, or ethnicity reference.

5. The system of claim 1, wherein the profile module marks at least one food preference attribute from a user profile input by a food preference marker, wherein said mark is based on matched food preference attributes listed in a pre-and, or and, or intelligently defined library.

6. The system of claim 1, wherein the user profile module creates a user profile based on a user profile input further comprising of any one of a questionnaire-led textual answers, user-volunteered textual input, video input, photograph input, social-media feed, search query, home address, geo-location, clicked items, ordered items, and, or provisioned items.

7. The system of claim 1, further comprising a rating system, wherein said rating system rates any one of a user based on at least one of a quality of service review, quality of food review, time of completion of order, and, or timely payment for order.

8. The system of claim 1, wherein the matching module matches user profile 1 with at least one user profile 2 based on at least any one of the following user profile inputs: today's menu, cook for me, cook with me, join my party, my signature dish, cook my recipe, cook with special dietary needs, join me at a restaurant, and, or exchange meal.

9. The system of claim 1, wherein the matching module matches a user 2 profile with a user 1 profile based on the highest matching rule score.

10. The system of claim 1, wherein the matching module matches a plurality of user 2 profiles with a user 1 profile based on a ranking of highest matching rule score.

11. The system of claim 1, wherein the matching module interacts with a notification system to notify any one of the users of any one of a highest scored match and, or a ranking of highest scored matches.

12. The system of claim 1, wherein the matching rule gives a highest weighted average to any one of a residential locations of user 1 and user 2, and, or geo-locations of user 1 and user 2.

13. The system of claim 1, wherein the matching rule gives a highest weighted average to a user rating of any one of user 1 and, or user 2.

14. The system of claim 1, wherein a user 1 may search and or scroll listed user profile 2 inputs, wherein the user 2 may input any one of a listed dish, location, time of service, price, delivery options.

15. The system of claim 1, wherein any one of a user 1 and, or user 2 gets notified of any one of the user 1 profile inputs and, or user 2 user profile inputs via a notification system.

16. The system of claim 1, further comprising receiving a portion of a confirmed order amount from any one of the user 1 profile payment agent and, or user profile 2 payment agent into an administrative payment account.

17. The system of claim 1, wherein the generic request trigger for the requester module is based on any one of a user 1 authorization, access, and, or initialization.

18. The system of claim 1, wherein the request module interacts with the matching module to initiate a short-cut match of user profile 1 with user profile 2 based only on geo-location.

19. A food ordering system comprising:
a requesting module;
a matching module;
a processor;
a storage element coupled to the processor;
encoded instructions;
wherein the system is configured to:
receive a generic request from a first user profile by the requesting module, wherein said generic request comprises any one of a first user authorization, access, and, or initialization; and
match the first user profile to at least one user profile from a plurality of member profiles by a matching module, wherein said match is based on geolocation inputs of the first user and at least one other user that have listed any one of a cooked item, cooking item, request receiving, and, or cooking active.

20. The system of claim 19, wherein acceptance of an order triggers transfer of at least a partial amount of the entire confirmed order amount from a first user to at least one other user.

21. The system of claim 19, wherein acceptance of an order triggers transfer of at least a partial amount of the entire confirmed order amount from a first user profile payment agent into a second user profile payment agent by a payment module.

22. The system of claim 19, wherein acceptance of an order triggers transfer of at least a partial amount of the entire confirmed order from a first user profile payment agent into an intermediary account and then to a second user profile payment agent by a payment module.

23. A method comprising, said method comprising the steps of:
receiving food preference attributes which enable a profile to be created by the profile module;
receiving a request from a first user profile by the requesting module, wherein said request comprises of a specific criteria related to any one of a potential dining experience, occasion, event, or a generic request;
matching the first user profile to at least one user profile from a plurality of member profiles by a matching module, wherein said match correlates tagged food preference attributes from a request or profile by the first user profile to tagged food preference attributes from at least one second user profile based on matching rule and score, further based on a number of, or a degree of tagged correlations; and
triggering transfer of at least a partial amount of the entire confirmed order amount from a first user profile payment agent into a second user profile payment agent by the payment module, upon acceptance between at least two user profiles.
